(19) United States
(12) Patent Application Publication
(10) Pub. No.: US 2023/0385648 A1
(43) Pub. Date: Nov. 30, 2023

(54) TRAINING METHODS AND APPARATUSES FOR OBJECT DETECTION SYSTEM

(71) Applicant: ALIPAY (HANGZHOU) INFORMATION TECHNOLOGY CO., LTD., Hangzhou (CN)

(72) Inventors: Weixiang Hong, Hangzhou (CN); Wang Ren, Hangzhou (CN); Jian Wang, Hangzhou (CN); Jingdong Chen, Hangzhou (CN); Jiangwei Lao, Hangzhou (CN); Wei Chu, Hangzhou (CN)

(73) Assignee: ALIPAY (HANGZHOU) INFORMATION TECHNOLOGY CO., LTD., Hangzhou (CN)

(21) Appl. No.: 18/323,651

(22) Filed: May 25, 2023

(30) Foreign Application Priority Data
May 25, 2022 (CN) 202210573722.0

(51) Int. Cl. G06N 3/084; G06N 3/0464

(52) U.S. Cl. CPC G06N 3/084; G06N 3/0464

(57) ABSTRACT

Implementations of the present specification disclose methods, apparatuses, and devices for training an object detection system by using a gradient fine-tuning technique. In one aspect, the method includes: providing a training image as input to the object detection system; processing the training image by the object detection system; determining a gradient norm of each neural network layer based on object annotation data and the detection result corresponding to the training image; and updating, for each neural network layer, parameter values of the neural network layer based on an average of gradient norms and the gradient norm of the neural network layer.

### CROSS-REFERENCE TO RELATED APPLICATIONS

This application claims priority to Chinese Patent Application No. 202210573722.0, filed on May 25, 2022, which is hereby incorporated by reference in its entirety.

### TECHNICAL FIELD

One or more embodiments of this specification relate to the field of machine learning technologies, and in particular, to training methods and apparatuses for an object detection system.

### BACKGROUND

The object detection technology aims to identify one or more objects in an image and locate different objects (give bounding boxes). Object detection is used in many scenarios such as self-driving and security systems.

Currently, mainstream object detection algorithms are mainly based on a deep learning model. However, existing related algorithms can hardly satisfy increasing needs in actual applications. Therefore, an object detection solution is needed, so that accuracy of a detection result can be ensured while a calculation amount is reduced, to better satisfy needs in actual applications.

### SUMMARY

One or more embodiments of this specification describe training methods for an object detection system. A new object detection algorithm architecture is designed by introducing both convolutional layers and attention layers into a backbone network, to relieve dependence of a deep learning architecture on pre-training, and effectively reduce a calculation amount needed to train the object detection system.

According to a first aspect, a training method for an object detection system is provided. The object detection system includes a backbone network and a head network, the backbone network includes several convolutional layers and several self-attention layers, and the method includes the following: a training image is input to the object detection system, where convolution processing is performed on the training image by using the several convolutional layers, to obtain a convolution representation; self-attention processing is performed based on the convolution representation by using the several attention layers, to obtain a feature map; and the feature map is processed by using the head network, to obtain a detection result of a target object in the training image; a gradient norm of each neural network layer is determined based on object annotation data and the detection result corresponding to the training image; and for each neural network layer, network parameters of the neural network layer are updated based on an average of the gradient norms and the gradient norm of the neural network layer.

In one embodiment, the detection result includes a classification result and a detection bounding box of the target object, and the object annotation data include an object classification result and an object annotation bounding box.

In one embodiment, the convolution representation includes C two-dimensional matrices, and the performing self-attention processing based on the convolution representation by using the several attention layers, to obtain a feature map includes the following: self-attention processing is performed, by using the several attention layers, on C vectors obtained by performing flattening processing based on the C two-dimensional matrices, to obtain Z vectors; and truncation and stack processing is respectively performed on the Z vectors to obtain Z two-dimensional matrices as the feature map.

In one embodiment, the head network includes a region proposal network (RPN) and a classification and regression layer, and the processing the feature map by using the head network, to obtain a detection result of a target object in the training image includes the following: a plurality of proposed regions that include the target object are determined by using the RPN based on the feature map; and a target object category and a bounding box that correspond to each proposed region are determined by using the classification and regression layer based on a region feature of the proposed region, and the target object category and the bounding box are used as the detection result.

In one embodiment, the determining a gradient norm of each neural network layer based on object annotation data and the detection result corresponding to the training image includes the following: a gradient of each neural network layer is calculated based on the object annotation data and the detection result by using a back propagation method; and a norm of the gradient of each neural network layer is calculated as a corresponding gradient norm.

In one embodiment, the object detection system includes a plurality of neural network layers, and the updating, for each neural network layer, network parameters of the neural network layer based on an average of the gradient norms and the gradient norms of the neural network layer includes the following: an average of a plurality of gradient norms corresponding to the plurality of neural network layers is calculated; and for each neural network layer, the network parameters of the neural network layer are updated based on a ratio of the gradient norm of the neural network layer to the average.

In one specific embodiment, the calculating an average of a plurality of gradient norms corresponding to the plurality of neural network layers includes the following: a geometric mean of the plurality of gradient norms is calculated.

In one specific embodiment, the updating, for each neural network layer, the network parameters of the neural network layer based on a ratio of the gradient norm of the neural network layer to the average includes the following: for each neural network layer, the ratio of the gradient norm of the neural network layer to the average is calculated; an exponentiation result obtained by using the ratio as the base and a predetermined value as the exponent is determined; and the network parameters of the neural network layer are updated to a product of the network parameters and the exponentiation result.

According to a second aspect, a training apparatus for an object detection system is provided. The object detection system includes a backbone network and a head network, the backbone network includes several convolutional layers and several self-attention layers, and the apparatus includes the following: an image processing unit, configured to process a training image by using the object detection system, where the image processing unit includes the following: a convolution subunit, configured to perform convolution processing on the training image by using the several convolutional layers, to obtain a convolution representation; an attention subunit, configured to perform self-attention processing based on the convolution representation by using the several attention layers, to obtain a feature map; and a processing subunit, configured to process the feature map by using the head network, to obtain a detection result of a target object in the training image; a gradient norm calculation unit, configured to determine a gradient norm of each neural network layer based on object annotation data and the detection result corresponding to the training image; and a network parameter update unit, configured to update, for each neural network layer, network parameters of the neural network layer based on an average of the gradient norms and the gradient norm of the neural network layer.

According to a third aspect, a computer-readable storage medium is provided, where the computer-readable storage medium stores a computer program, and when the computer program is executed on a computer, the computer is enabled to perform the method according to the first aspect.

According to a fourth aspect, a computing device is provided, including a memory and a processor, where the memory stores executable code, and when executing the executable code, the processor implements the method according to the first aspect.

According to the methods and the apparatuses provided in the embodiments of this specification, the backbone network in the object detection system is configured as a hybrid architecture including convolutional layers and self-attention layers. In addition, a gradient fine-tuning technique is proposed to adjust the training gradients of each neural network layer in the object detection system, so that good precision can also be achieved by directly performing single-stage training without performing pre-training on the object detection system.

### BRIEF DESCRIPTION OF DRAWINGS

To describe the technical solutions in the embodiments of this application more clearly, the following briefly describes the accompanying drawings needed for describing the embodiments. Clearly, the accompanying drawings in the following descriptions show merely some embodiments of this application, and a person of ordinary skill in the art can still derive other drawings from these accompanying drawings without creative efforts.

FIG. 1 is a schematic diagram illustrating a system architecture of an object detection system, according to an embodiment;

FIG. 2 is a schematic flowchart illustrating a training method for an object detection system, according to an embodiment;

FIG. 3 is a schematic structural diagram illustrating a self-attention block in a Transformer mechanism;

FIG. 4 is a schematic diagram illustrating a process of processing an image by using an object detection system, according to an embodiment; and

FIG. 5 is a schematic structural diagram illustrating a training apparatus for an object detection system, according to an embodiment.

### DESCRIPTION OF EMBODIMENTS

The following describes the solutions provided in this specification with reference to the accompanying drawings.

As described above, current mainstream object detection algorithms are mainly based on a deep learning architecture. However, because the deep learning model has a large number of parameters, a current object detector generally needs two steps of training to achieve good precision. The two steps of training include pre-training and fine-tuning. Pre-training generally takes a long time to perform training in a very large data set (for example, an ImageNet data set), and consumes a very large number of computing resources. Fine-tuning is to briefly train a pre-trained model in a target data set (such as a COCO data set and actual service data), so that the model fits the data.

Popular deep learning architectures include a convolutional neural network (CNN) and a Transformer. Because pre-training excessively consumes time and computing resources, in the era when the CNN network was the mainstream detector framework, many researchers have explored how to achieve a good detection effect while discarding pre-training. Unfortunately, their success cannot be replicated in the transformer architecture, that is, it is currently not possible to train a Transformer-based detector to have good precision without pre-training.

Further, the inventor finds that the convolutional layer in the CNN network has an inductive bias that can be understood as a prior knowledge. Generally, a stronger prior knowledge indicates weaker dependence on pre-training. The inductive bias of the CNN network includes locality, that is, there is a relationship between pixel blocks with spatial positions close to each other and there is no relationship between pixel blocks with spatial positions far from each other, and includes spatial invariance, for example, a tiger is a tiger either on the left or the right of an image. In addition, the self-attention layer in the Transformer allows for a global attention mechanism that consumes a large number of compute and strongly depends on pre-training. However, in the pre-training phase, a self-attention layer near the input end actually determines the inductive bias, and behaves like a convolution operation.

Based on this, the inventor proposes to replace the first several self-attention layers close to the input end in the Transformer-based deep learning architecture with convolutional layers, thereby directly reducing dependence of the Transformer-based detector on pre-training.

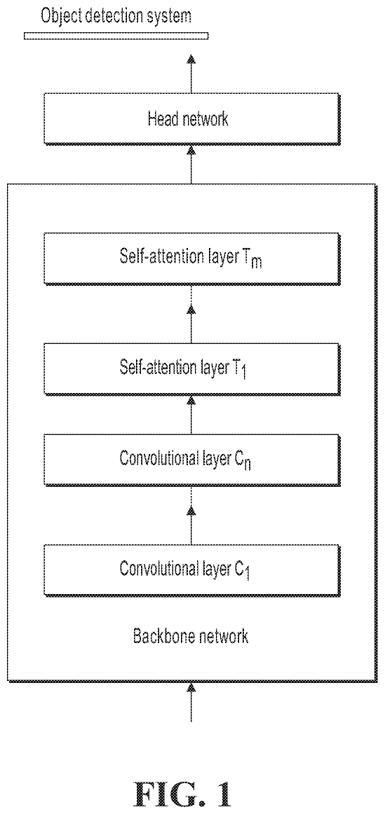

FIG. 1 is a schematic diagram illustrating a system architecture of an object detection system, according to an embodiment. As shown in FIG. 1, the object detection system includes a backbone network and a head network. The backbone network is used to perform encoding representation on an image, and includes several convolutional layers and several self-attention layers that are respectively shown as m convolutional layers and n self-attention layers in FIG. 1. The head network is used to determine an object detection box and a classification category based on the encoding representation. It should be understood that “several” in this specification means one or more, and values of m and n can be set and adjusted based on actual needs.

However, network structures of the convolutional layer and the attention layer differ greatly, and a good effect can hardly be achieved by directly performing training based on a conventional method. In practice, the inventor finds that a gradient of the attention layer is ten times higher than a gradient of the convolutional layer, and therefore proposes a gradient fine-tuning technique, so that the above-mentioned object detection system can obtain good training performance.

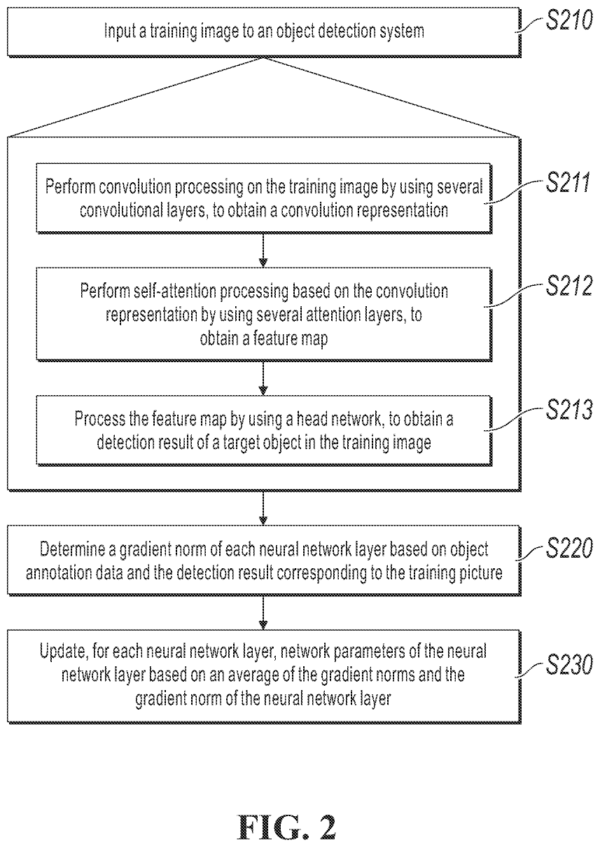

FIG. 2 is a schematic flowchart illustrating a training method for an object detection system, according to an embodiment. The method can be performed by any platform, server, or device cluster that has a calculation and processing capability. As shown in FIG. 2, the method includes the following steps.

Step S210: Input a training image to the object detection system. Specifically, in substep S211, convolution processing is performed on the training image by using several convolutional layers, to obtain a convolution representation. In substep S212, self-attention processing is performed based on the convolution representation by using several attention layers, to obtain a feature map. In substep S213, the feature map is processed by using the head network, to obtain a detection result of a target object in the training image. Step S220: Determine a gradient norm of each neural network layer based on object annotation data and the detection result corresponding to the training image. Step S230: Update, for each neural network layer, network parameters of the neural network layer based on an average of the gradient norms and the gradient norm of the neural network layer.

The above-mentioned steps are described in detail as follows:
First, in step S210, the training image is input to the object detection system, and the detection result of the target object in the training image is output. Specifically, step S210 includes the following sub steps:
Step S211: Perform convolution processing on the training image by using the several convolutional layers, to obtain the convolution representation.

It is worthwhile to note that convolution processing (or a convolution operation) is a commonly used operation when an image is analyzed. Through convolution processing, abstract features can be extracted from a pixel matrix of an original image. Based on a design of a convolution kernel, these abstract features can reflect, for example, more global features such as a line shape and color distribution of a region in the original image. Further, convolution processing means using several convolution kernels in a single convolutional layer to perform convolution calculation on an image representation (usually a three-dimensional tensor) that is input to the layer. Specifically, when convolution calculation is performed, each of the several convolution kernels is slid over a feature matrix corresponding to a height dimension and a width dimension in the image representation. For each stride, a product of each element in the convolution kernel and a value of a matrix element covered by the element is multiplied, and the products are summed. As such, a new image representation can be obtained.

Each of the several convolutional layers, that is, one or more convolutional layers, performs convolution processing on an image representation output by a previous convolutional layer of the convolutional layer, so that an image representation output by the last convolutional layer is used as the above-mentioned convolution representation. It can be understood that an input of the first convolutional layer is an original training image.

In one embodiment, a rectified linear unit (ReLU) activation layer is further disposed between some of the several convolutional layers or after a certain convolutional layer, to perform non-linear mapping on an output result of the convolutional layer. A result of non-linear mapping can be input to a next convolutional layer for further convolution processing, or can be output as the above-mentioned convolution representation. In other embodiments, a pooling layer is further disposed between some convolutional layers, to perform a pooling operation on an output result of the convolutional layer. The result of the pooling operation can be input to a next convolutional layer to continue to perform a convolution operation. In still other embodiments, a residual block is further disposed after a certain convolutional layer. The residual block performs addition processing on an input and an output of the certain convolutional layer, and uses a result of the addition processing as an input of a next convolutional layer or the ReLU activation layer.

In the above-mentioned descriptions, one or more convolutional layers can be used, and the ReLU activation layer and/or the pooling layer can be selectively added based on needs, to process the above-mentioned training image and obtain a corresponding convolution representation.
Step S212: Perform self-attention processing based on the convolution representation by using the several attention layers, to obtain the feature map.

It is worthwhile to note that an output of the convolutional layer and an input of the attention layer generally have different data formats. Therefore, the convolution representation needs to be reshaped, and then the reshaped convolution representation is used as an input of the attention layer. Specifically, the convolution representation is generally a three-dimensional tensor, and can be denoted as (W, H, C), where W and H respectively correspond to a width dimension and a height dimension of an image, and C is a number of channels. In this case, the convolution representation can also be considered as C two-dimensional matrices. However, the input of the attention layer needs to be a vector sequence. Therefore, it is proposed to perform flattening processing on the W dimension and the H dimension. That is, for each of the C two-dimensional matrices, row vectors in the matrix are sequentially spliced to obtain a corresponding one-dimensional vector, so that C (W*H)-dimensional vectors can be obtained, to form a vector sequence. Therefore, the vector sequence can be used as an input of the first attention layer in the several attention layers. In addition, both formats of an input and an output of the attention layer are vector sequences, or the input and the output can be considered as matrices forming vector sequences.

The above-mentioned self-attention processing is a processing method where a self-attention mechanism is introduced. The self-attention mechanism is one of attention mechanisms. When processing information, a human selectively pays attention to a part of all information, and ignores other visible information. This mechanism is generally referred to as the attention mechanism, and the self-attention mechanism means that external information is not introduced when existing information is processed. For example, when each word in a sentence is encoded by using the self-attention mechanism, only information about all words in the sentence is referenced, and text content other than the sentence is not introduced.

In this step, a self-attention processing method in the Transformer mechanism can be used for reference. Specifically, for any i^{th} attention layer in the several attention layers, an input matrix of the i^{th} attention layer can be denoted as Z⁽ⁱ⁾. Therefore, for the i^{th} attention layer, the matrix Z⁽ⁱ⁾ is first respectively projected to a query space, a key space, and a value space, to obtain a query matrix Q, a key matrix K, and a value matrix V. Then, an attention weight is determined by using the query matrix Q and the key matrix K, and the value matrix V is transformed by using the determined attention weight, so that a matrix Z⁽ⁱ⁺¹⁾ obtained through transformation is used as an output of the current attention layer.

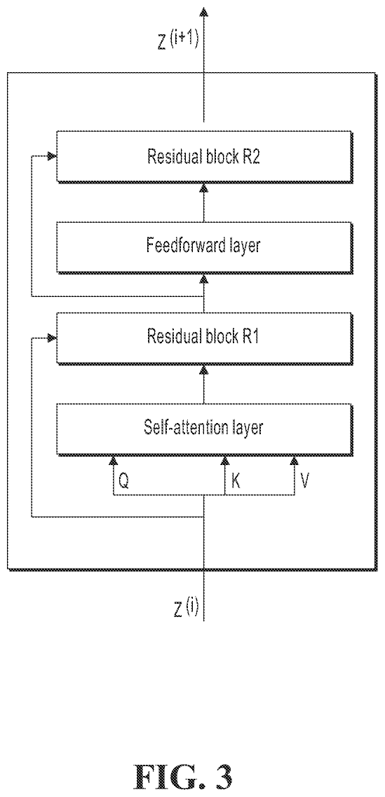

In one embodiment, a residual block and a feedforward layer can be further designed to form a self-attention block together with the self-attention layer, to process the above-mentioned convolution representation. FIG. 3 is a schematic structural diagram illustrating a self-attention block in a Transformer mechanism. As shown in FIG. 3, the self-attention block includes an attention layer, a residual block, a feedforward layer, and another residual block that are sequentially connected. The self-attention layer first processes a matrix Z⁽ⁱ⁾ input to the layer, to obtain a matrix output by the self-attention layer. The residual block R1 first performs addition processing on the output matrix and the above-mentioned matrix Z⁽ⁱ⁾, and then performs normalization processing. The feedforward layer performs linear transformation and non-linear transformation on an output of the residual block R1, and an output of the layer continues to be processed by the residual block R2, to obtain an output matrix Z⁽ⁱ⁾ of the current self-attention block. Further, if the current self-attention block is followed by another self-attention block, the output matrix can be used as an input of the next attention block. Otherwise, the above-mentioned feature map can be determined based on the output matrix.

In the above-mentioned descriptions, a matrix (or a vector sequence) output by each self-attention layer or each self-attention block can be obtained, to determine the above-mentioned feature map. In one embodiment, the feature map can be determined based on an output of the last self-attention layer in the several self-attention layers or based on an output of the last self-attention block in the several self-attention blocks. In other embodiments, the feature map can be determined based on an average matrix of all matrices output by all self-attention layers or all self-attention blocks.

Further, a reverse operation corresponding to the above-mentioned flattening processing is performed on the output vector sequence, to obtain the feature map. Specifically, for each vector in the vector sequence, the vector is truncated to a predetermined number of sub-vectors that have the same length as each other, and then the sub-vectors are stacked to obtain a corresponding two-dimensional matrix. Therefore, S two-dimensional matrices corresponding to a plurality of (that can be denoted as S) vectors included in the vector sequence can be obtained, to form the feature map.

In the above-mentioned descriptions, self-attention processing can be performed on the convolution representation, to obtain the feature map of the training image.
Step S213: Process the feature map by using the head network, to obtain the detection result of the target object in the training image.

It is worthwhile to note that for the head network, a head network in an anchor-based object detection algorithm such as a faster region-based convolutional neural network (Faster-RCNN) or a feature pyramid network (FPN) can be used, or a head network in an anchor-free object detection algorithm can be used. The head network in the classic Faster-RCNN algorithm is used as an example below to describe implementation of the step.

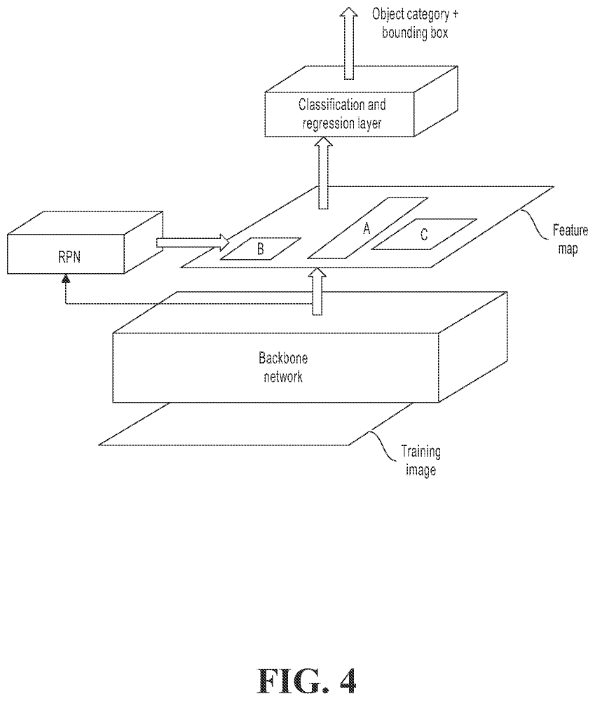

FIG. 4 is a schematic diagram illustrating a process for processing an image by using an object detection system, according to an embodiment. The head network includes a region proposal network (RPN) and a classification and regression layer shown in the figure.

Specifically, a plurality of proposed regions (RP) that include the target object are first determined by using the RPN based on the feature map. The proposed region is a region where an object may appear in an image. In some cases, the proposed region is also referred to as a region of interest. The proposed region is determined to provide a basis for subsequent object classification and determining of regression of a bounding box. As shown in the example in FIG. 4, in an example, the RPN recommends region bounding boxes of three proposed regions in the feature map, and the region bounding boxes are respectively represented as regions A, B, and C.

Then, the feature map and generation results of the plurality of proposed regions based on the feature map are input to the classification and regression layer. For each proposed region, the classification and regression layer determines an object category and a bounding box in the proposed region based on a region feature of the proposed region.

Based on one implementation, the classification and regression layer is a fully-connected layer, and object category classification and bounding box regression are performed based on a region feature of each region input to a previous layer. More specifically, the classification and regression layer can include a plurality of classifiers, the classifiers are trained to identify objects of different categories in a proposed region. In an animal detection scenario, the classifiers are trained to identify animals of different categories such as a tiger, a lion, a starfish, and a swallow.

The classification and regression layer further includes a regressor used to perform regression on a bounding box corresponding to an identified object, and determine that a minimum rectangular region surrounding the object is a bounding box.

Therefore, the detection result of the training image can be obtained, including a classification result and a detection bounding box of the target object.

After the training image is processed by using the object detection system to obtain the corresponding detection result, step S220 is performed to determine the gradient norm of each neural network layer based on the object annotation data and the detection result corresponding to the training image. It should be understood that the object detection system includes a plurality of neural network layers. The neural network layer is generally a network layer that includes weight parameters to be determined, for example, the self-attention layer and the convolutional layer in the backbone network.

As mentioned above, network structures of the convolutional layer and the attention layer differ greatly, and a good effect can hardly be achieved by performing training based on a conventional method. Therefore, a gradient fine-tuning technique is proposed. Specifically, there is a large difference between a gradient of the attention layer and a gradient of the convolutional layer, and actual experience shows that minor adjustment of parameters of all network layers result in a trained model with a better effect than large adjustment of parameters of certain network layers. Therefore, the inventor proposes that, after the gradient of each network layer in the object detection system is calculated, parameter adjustment is not directly performed by using an original gradient. Instead, an average of the gradient norms of all the neural network layers in the object detection system is calculated, and it is determined, based on the average, whether the gradient of each network layer is large or small, and a magnitude is determined. Then, the network parameters of each layer are adjusted based on the obtained deviation magnitude, so that the parameters are close to the obtained average.

In one embodiment, a gradient of each neural network layer can be calculated based on the object annotation data and the detection result corresponding to the training image by using a back propagation method. Then, a norm of the gradient of each neural network layer is calculated as a corresponding gradient norm. The object annotation data include an object classification result and an object annotation bounding box, and can be obtained through manual marking. In other embodiments, a gradient of one neural network layer can be calculated to trigger calculation of a gradient norm without waiting for all gradients of all the layers to be calculated before calculation of the gradient norm.

Gradient calculation can be implemented by using an existing technology. For calculation of the gradient norm, a first-order norm, a second-order norm, etc. can be calculated. Based on an example, the following equation (1) can be used to calculate a gradient norm C_{i,j} of parameters in a j^{th} neuron in any i^{th} network layer, and then a gradient norm Cᵢ corresponding to the i^{th} network layer is calculated based on the equation (2):

C_{i,j}= [symbol] [(zᵢ₋₁*yᵢ(j))²] (1)

Cᵢ= [symbol] ⱼ[C_{i,j}] (2)

In the equation (1), zᵢ₋₁ represents an output of an activation function in an (i−1)th neural network layer, yᵢ(j) represents a back propagation error of the j^{th} neuron in the i^{th} network layer, and a calculation result of zᵢ₋₁*yᵢ(j) is the gradient of the parameters in the j^{th} neuron in the i^{th} network layer.

Therefore, the gradient norm Cᵢ of each neural network layer can be determined.

Then, in step S230, for each neural network layer, the network parameters of the neural network layer are updated based on the gradient norm of the neural network layer and an average of a plurality of gradient norms corresponding to the plurality of neural network layers.

In one embodiment, an arithmetic mean of the plurality of gradient norms can be calculated, that is, the gradient norms are summed and then divided by a total number. In other embodiments, a geometric mean of the plurality of gradient norms can be calculated, that is, the plurality of gradient norms are multiplied and then the n^{th} root is taken, where n is equal to the total number. This operation can be performed according to the following equation (3):

$$\overline{C} = {( {Π}_{i} {C}_{i} )}^{\frac{1}{N}} \qquad ( 3 )$$

In one embodiment, for each neural network layer, a ratio of the gradient norm Cᵢ of the neural network layer to the average C̅ is calculated to update the network parameters of the neural network layer based on the ratio. In one specific embodiment, an exponentiation result obtained by using the ratio as the base and a predetermined value α (for example, α=0.25) as the exponent can be first determined, that is, rᵢ=(Cᵢ/C̅)^{α}. Further, the network parameters Wᵢ of the neural network layer are updated to a product of the network parameters and the exponentiation result, and can be denoted as Wᵢ←rᵢWᵢ. In other specific embodiments, the network parameters of the neural network layer can be directly updated to a product of the network parameters and the ratio. As such, the network parameters of the object detection system can be effectively updated.

In conclusion, according to the training methods for an object detection system disclosed in the embodiments of this specification, the backbone network in the object detection system is configured as a hybrid architecture including convolutional layers and self-attention layers. In addition, a gradient fine-tuning technique is proposed to adjust the training gradients of each neural network layer in the object detection system, so that good precision can also be achieved by directly performing single-stage training without performing pre-training on the object detection system.

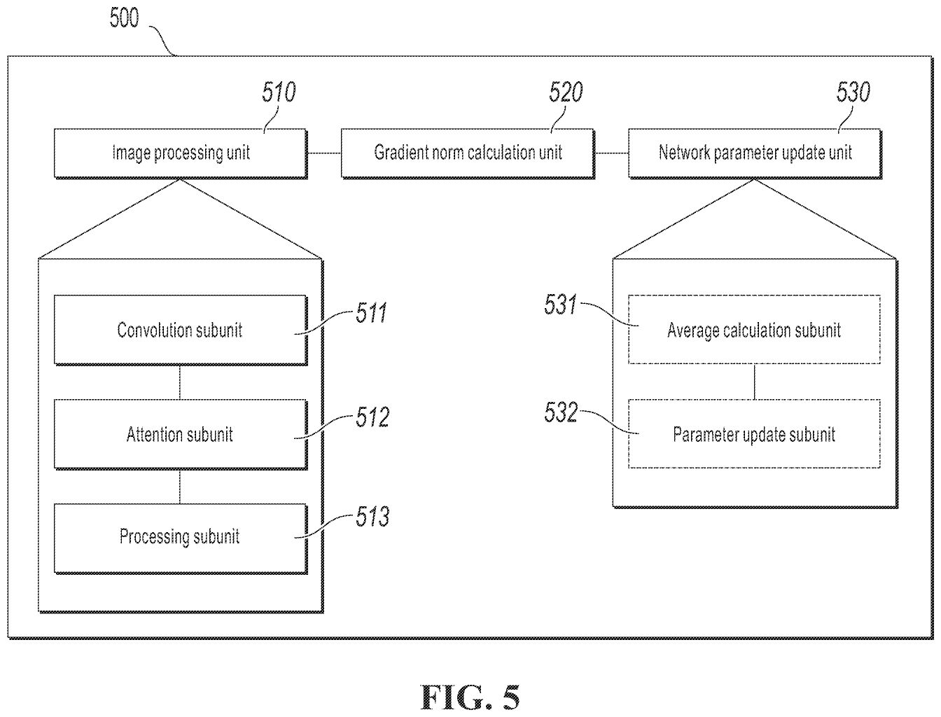

Corresponding to the above-mentioned training method, the embodiments of this specification further disclose a training apparatus. FIG. 5 is a schematic structural diagram illustrating a training apparatus for an object detection system, according to an embodiment. The object detection system includes a backbone network and a head network, and the backbone network includes several convolutional layers and several self-attention layers. As shown in FIG. 5, the apparatus 500 includes the following: an image processing unit 510, configured to process a training image by using the object detection system, where the image processing unit 510 includes the following: a convolution subunit 511, configured to perform convolution processing on the training image by using the several convolutional layers, to obtain a convolution representation; an attention subunit 512, configured to perform self-attention processing based on the convolution representation by using the several attention layers, to obtain a feature map; and a processing subunit 513, configured to process the feature map by using the head network, to obtain a detection result of a target object in the training image; a gradient norm calculation unit 520, configured to determine a gradient norm of each neural network layer based on object annotation data and the detection result corresponding to the training image; and a network parameter update unit 530, configured to update, for each neural network layer, network parameters of the neural network layer based on an average of the gradient norms and the gradient norm of the neural network layer.

In one embodiment, the detection result includes a classification result and a detection bounding box of the target object, and the object annotation data include an object classification result and an object annotation bounding box.

In one embodiment, the convolution representation includes C two-dimensional matrices, and the attention subunit 512 is specifically configured to perform, by using the several attention layers, self-attention processing on C vectors obtained by performing flattening processing based on the C two-dimensional matrices, to obtain Z vectors; and respectively perform truncation and stack processing on the Z vectors to obtain Z two-dimensional matrices as the feature map.

In one embodiment, the head network includes an RPN and a classification and regression layer, and the processing subunit 513 is specifically configured to determine, by using the RPN based on the feature map, a plurality of proposed regions that include the target object; and determine, by using the classification and regression layer based on a region feature of each proposed region, a target object category and a bounding box that correspond to the proposed region, and use the target object category and the bounding box as the detection result.

In one embodiment, the gradient norm calculation unit 520 is specifically configured to calculate a gradient of each neural network layer based on the object annotation data and the detection result by using a back propagation method; and calculate a norm of the gradient of each neural network layer as a corresponding gradient norm.

In one embodiment, the object detection system includes a plurality of neural network layers, and the network parameter update unit 530 includes the following: an average calculation subunit 531, configured to calculate an average of a plurality of gradient norms corresponding to the plurality of neural network layers; and a parameter update subunit 532, configured to update, for each neural network layer, the network parameters of the neural network layer based on a ratio of the gradient norm of the neural network layer to the average.

In one embodiment, the average calculation subunit 531 is specifically configured to calculate a geometric mean of the plurality of gradient norms.

In one embodiment, the parameter update subunit 532 is specifically configured to calculate, for each neural network layer, the ratio of the gradient norm of the neural network layer to the average; determine an exponentiation result obtained by using the ratio as the base and a predetermined value as the exponent; and update the network parameters of the neural network layer to a product of the network parameters and the exponentiation result.

In conclusion, according to the training apparatuses for an object detection system disclosed in the embodiments of this specification, the backbone network in the object detection system is configured as a hybrid architecture including convolutional layers and self-attention layers. In addition, a gradient fine-tuning technique is proposed to adjust the training gradients of each neural network layer in the object detection system, so that good precision can also be achieved by directly performing single-stage training without performing pre-training on the object detection system.

In embodiments of another aspect, a computer-readable storage medium is further provided. The computer-readable storage medium stores a computer program. When the computer program is executed on a computer, the computer is enabled to perform the method described with reference to FIG. 2.

In embodiments of still another aspect, a computing device is further provided, including a memory and a processor. The memory stores executable code, and when executing the executable code, the processor implements the method the method described with reference to FIG. 2. A person skilled in the art should be aware that in the above-mentioned one or more examples, functions described in this application can be implemented by hardware, software, firmware, or any combination thereof. When this application is implemented by software, the functions can be stored in a computer-readable medium or transmitted as one or more instructions or code in the computer-readable medium.

The objectives, technical solutions, and beneficial effects of this application are further described in detail in the above-mentioned specific implementations. It should be understood that the above-mentioned descriptions are merely specific implementations of this application, but are not intended to limit the protection scope of this application. Any modification, equivalent replacement, or improvement made based on the technical solutions of this application shall fall within the protection scope of this application.

What is claimed is:

1. A method for training an object detection system comprising multiple neural network layers, wherein the method comprises:
providing a training image as input to the object detection system, wherein the object detection system comprises a backbone network and a head network, the backbone network comprising multiple convolutional layers and multiple self-attention layers;
processing the training image by the object detection system, wherein the processing comprises performing convolution processing on the training image by using the multiple convolutional layers to obtain a convolution representation, performing self-attention processing on the convolution representation by using the multiple self-attention layers to obtain a feature map, and processing the feature map by using the head network to obtain a detection result of a target object in the training image;
determining a gradient norm of each neural network layer based on object annotation data and the detection result corresponding to the training image; and
updating, for each neural network layer, parameter values of the neural network layer based on an average of gradient norms and the gradient norm of the neural network layer.

2. The method of claim 1, wherein the detection result comprises a classification result and a detection bounding box of the target object, and wherein the object annotation data comprises a classification annotation result and an annotation bounding box.

3. The method of claim 1, wherein the convolution representation comprises C two-dimensional matrices, and wherein performing self-attention processing comprises:
performing, by using the multiple self-attention layers, self-attention processing on C vectors obtained by performing flattening processing based on the C two-dimensional matrices, to obtain Z vectors; and
respectively performing truncation and stack processing on the Z vectors to obtain Z two-dimensional matrices as the feature map.

4. The method of claim 1, wherein the head network comprises a region proposal network (RPN) and a classification and regression layer, and wherein processing the feature map by using the head network comprises:
determining, by using the RPN based on the feature map, a plurality of proposed regions that are predicted to comprise the target object;
determining, by using the classification and regression layer and based on a region feature of each proposed region, a target object category and a bounding box that correspond to the proposed region; and
using the target object category and the bounding box for each proposed region as the detection result.

5. The method of claim 1, wherein determining a gradient norm of each neural network layer based on object annotation data and the detection result corresponding to the training image, comprises:
calculating, by using a back propagation technique, a gradient of each neural network layer based on the object annotation data and the detection result; and
calculating a norm of the gradient of each neural network layer as the gradient norm of each neural network layer.

6. The method of claim 1, wherein updating, for each neural network layer, parameter values of the neural network layer based on an average of gradient norms and the gradient norm of the neural network layer, comprises:
calculating an average of multiple gradient norms corresponding, respectively, to the multiple neural network layers; and
updating, for each neural network layer, the parameter values of the neural network layer based on a ratio of the gradient norm of the neural network layer to the average of multiple gradient norms.

7. The method of claim 6, wherein calculating an average of multiple gradient norms corresponding, respectively, to the multiple neural network layers, comprises:
calculating a geometric mean of the multiple gradient norms.

8. The method of claim 6, wherein updating, for each neural network layer, the parameter values of the neural network layer based on a ratio of the gradient norm of the neural network layer to the average of gradient norms, comprises:
for each neural network layer, calculating the ratio of the gradient norm of the neural network layer to the average of gradient norms;
determining an exponentiation result obtained by using the ratio as a base and a predetermined value as an exponent; and
updating the parameter values of the neural network layer to be a product of the parameter values of the neural network layer and the exponentiation result.

9. A system, comprising:
one or more computers; and
one or more computer memory devices interoperably coupled with the one or more computers and having tangible, non-transitory, machine-readable media storing one or more instructions that, when executed by the one or more computers, perform operations for training an object detection system comprising multiple neural network layers, wherein the operations comprise:
providing a training image as input to the object detection system, wherein the object detection system comprises a backbone network and a head network, the backbone network comprising multiple convolutional layers and multiple self-attention layers;
processing the training image by the object detection system, wherein the processing comprises performing convolution processing on the training image by using the multiple convolutional layers to obtain a convolution representation, performing self-attention processing on the convolution representation by using the multiple self-attention layers to obtain a feature map, and processing the feature map by using the head network to obtain a detection result of a target object in the training image;
determining a gradient norm of each neural network layer based on object annotation data and the detection result corresponding to the training image; and
updating, for each neural network layer, parameter values of the neural network layer based on an average of gradient norms and the gradient norm of the neural network layer.

10. The system of claim 9, wherein the detection result comprises a classification result and a detection bounding box of the target object, and wherein the object annotation data comprises a classification annotation result and an annotation bounding box.

11. The system of claim 9, wherein the convolution representation comprises C two-dimensional matrices, and wherein performing self-attention processing comprises:
performing, by using the multiple self-attention layers, self-attention processing on C vectors obtained by performing flattening processing based on the C two-dimensional matrices, to obtain Z vectors; and
respectively performing truncation and stack processing on the Z vectors to obtain Z two-dimensional matrices as the feature map.

12. The system of claim 9, wherein the head network comprises a region proposal network (RPN) and a classification and regression layer, and wherein processing the feature map by using the head network comprises:
determining, by using the RPN based on the feature map, a plurality of proposed regions that are predicted to comprise the target object;
determining, by using the classification and regression layer and based on a region feature of each proposed region, a target object category and a bounding box that correspond to the proposed region; and
using the target object category and the bounding box for each proposed region as the detection result.

13. The system of claim 9, wherein determining a gradient norm of each neural network layer based on object annotation data and the detection result corresponding to the training image, comprises:
calculating, by using a back propagation technique, a gradient of each neural network layer based on the object annotation data and the detection result; and
calculating a norm of the gradient of each neural network layer as the gradient norm of each neural network layer.

14. The system of claim 9, wherein updating, for each neural network layer, parameter values of the neural network layer based on an average of gradient norms and the gradient norm of the neural network layer, comprises:
calculating an average of multiple gradient norms corresponding, respectively, to the multiple neural network layers; and
updating, for each neural network layer, the parameter values of the neural network layer based on a ratio of the gradient norm of the neural network layer to the average of multiple gradient norms.

15. The system of claim 14, wherein calculating an average of multiple gradient norms corresponding, respectively, to the multiple neural network layers, comprises:
calculating a geometric mean of the multiple gradient norms.

16. The system of claim 14, wherein updating, for each neural network layer, the parameter values of the neural network layer based on a ratio of the gradient norm of the neural network layer to the average of gradient norms, comprises:
for each neural network layer, calculating the ratio of the gradient norm of the neural network layer to the average of gradient norms;
determining an exponentiation result obtained by using the ratio as a base and a predetermined value as an exponent; and
updating the parameter values of the neural network layer to be a product of the parameter values of the neural network layer and the exponentiation result.

17. A non-transitory, computer-readable medium storing one or more instructions executable by a computer system to perform operations for training an object detection system comprising multiple neural network layers, wherein the operations comprise:
providing a training image as input to the object detection system, wherein the object detection system comprises a backbone network and a head network, the backbone network comprising multiple convolutional layers and multiple self-attention layers;
processing the training image by the object detection system, wherein the processing comprises performing convolution processing on the training image by using the multiple convolutional layers to obtain a convolution representation, performing self-attention processing on the convolution representation by using the multiple self-attention layers to obtain a feature map, and processing the feature map by using the head network to obtain a detection result of a target object in the training image;
determining a gradient norm of each neural network layer based on object annotation data and the detection result corresponding to the training image; and
updating, for each neural network layer, parameter values of the neural network layer based on an average of gradient norms and the gradient norm of the neural network layer.

18. The computer-readable medium of claim 17, wherein the detection result comprises a classification result and a detection bounding box of the target object, and wherein the object annotation data comprises a classification annotation result and an annotation bounding box.

19. The computer-readable medium of claim 17, wherein the convolution representation comprises C two-dimensional matrices, and wherein performing self-attention processing comprises:
performing, by using the multiple self-attention layers, self-attention processing on C vectors obtained by performing flattening processing based on the C two-dimensional matrices, to obtain Z vectors; and
respectively performing truncation and stack processing on the Z vectors to obtain Z two-dimensional matrices as the feature map.

20. The computer-readable medium of claim 17, wherein the head network comprises a region proposal network (RPN) and a classification and regression layer, and wherein processing the feature map by using the head network comprises:
determining, by using the RPN based on the feature map, a plurality of proposed regions that are predicted to comprise the target object;
determining, by using the classification and regression layer and based on a region feature of each proposed region, a target object category and a bounding box that correspond to the proposed region; and
using the target object category and the bounding box for each proposed region as the detection result.
